(19) United States
(12) Patent Application Publication
(10) Pub. No.: US 2015/0188339 A1
(43) Pub. Date: Jul. 2, 2015

(54) WIRELESS CHARGING DEVICE HAVING CONCAVE CHARGING STATION

(71) Applicants: Evan R. Green, Tualatin, OR (US); MIchael R. Bynum, Portland, OR (US); Nicholas A. Redfield, Portland, OR (US)

(72) Inventors: Evan R. Green, Tualatin, OR (US); MIchael R. Bynum, Portland, OR (US); Nicholas A. Redfield, Portland, OR (US)

(21) Appl. No.: 14/141,739

(22) Filed: Dec. 27, 2013

(51) Int. Cl. H02J 7/00; H02J 7/02

(52) U.S. Cl. CPC H02J 7/0042; H02J 7/025

(57) ABSTRACT

Systems and methods may provide for wirelessly charging an electronic device powered by a rechargeable battery. The wireless charging device may simultaneously charge one or more electronic devices regardless of location and spatial orientation relative to the wireless charging device by inducing at least one electromagnetic field into a charging platform having a concave cross-section.

### TECHNICAL FIELD

Embodiments generally relate to a wireless charging device, and more particularly, to a wireless charging device having a charging station with concave cross-section and which simultaneously charges one or more electronic devices regardless of location and spatial orientation relative to the wireless charging device.

### BACKGROUND

An electronic device powered by an internal rechargeable battery, generally requires recharging of the battery. Current wireless charging platforms generally have charging device with a charging pad having a generally flat, planar charging surface and a transmitter which sends a charging signal received by a receiver arranged in the electronic device. Use of such a charging pad, however, requires orienting the electronic device in close spatial proximity at a specific location on the pad such that its power receiver is properly operationally aligned with the power transmitter of the charging pad.

### BRIEF DESCRIPTION OF THE DRAWINGS

The various advantages of the embodiments will become apparent to one skilled in the art by reading the following specification and appended claims, and by referencing the following drawings, in which:

FIG. 1 is a front perspective view of an example of a wireless charging device, in accordance with embodiments;

FIG. 2 is a rear perspective view of an example of a wireless charging device, in accordance with embodiments;

FIG. 3 is a front view of an example of a wireless charging device, in accordance with embodiments;

FIG. 4 is a rear view of an example of a wireless charging device, in accordance with embodiments;

FIG. 5 is a side view of an example of a wireless charging device, in accordance with embodiments;

FIG. 6 is a side view of an example of a wireless charging device, in accordance with embodiments;

FIG. 7 is a top view of an example of a wireless charging device, in accordance with embodiments;

FIG. 8 is a bottom view of an example of a wireless charging device, in accordance with embodiments;

FIG. 9 is a perspective view of an example of a charging station of a wireless charging device, in accordance with embodiments;

FIG. 10A is a bottom view of an example of arrangement of a transmitter coil on a charging station of a wireless charging device, in accordance with embodiments;

FIG. 10B is a top view of an example of the transmitter coil of FIG. 10A, in accordance with embodiments;

FIG. 11 is a 3D perspective view of an example of an array of transmitter coils on a charging station of a wireless charging device, in accordance with embodiments;

FIG. 12A is a bottom view of an example of a three-transmitter coil array for a wireless charging device, in accordance with embodiments;

FIG. 12B is a plan view of an example of a transmitter coil in the three-transmitter coil array of FIG. 12A, in accordance with embodiments;

FIG. 13A is a bottom view of an example of a four-transmitter coil array for a wireless charging device, in accordance with embodiments;

FIG. 13B is a plan view of an example of a transmitter coil in the four-transmitter coil array of FIG. 13A, in accordance with embodiments;

FIG. 14 is a diagram of an example of the angle of incidence of an electromagnetic field relative to an receiving coil of an electronic device, in accordance with embodiments;

FIG. 15 is a block diagram of an example of a wireless charging device, in accordance with embodiments;

FIGS. 16A to 16C are flowcharts respective examples of a method of wirelessly charging an electronic device, in accordance with embodiments; and

FIG. 17 is a plan view of an example of a plurality of electronic devices on a charging surface of a wireless charging device, in accordance with embodiments.

### DESCRIPTION OF EMBODIMENTS

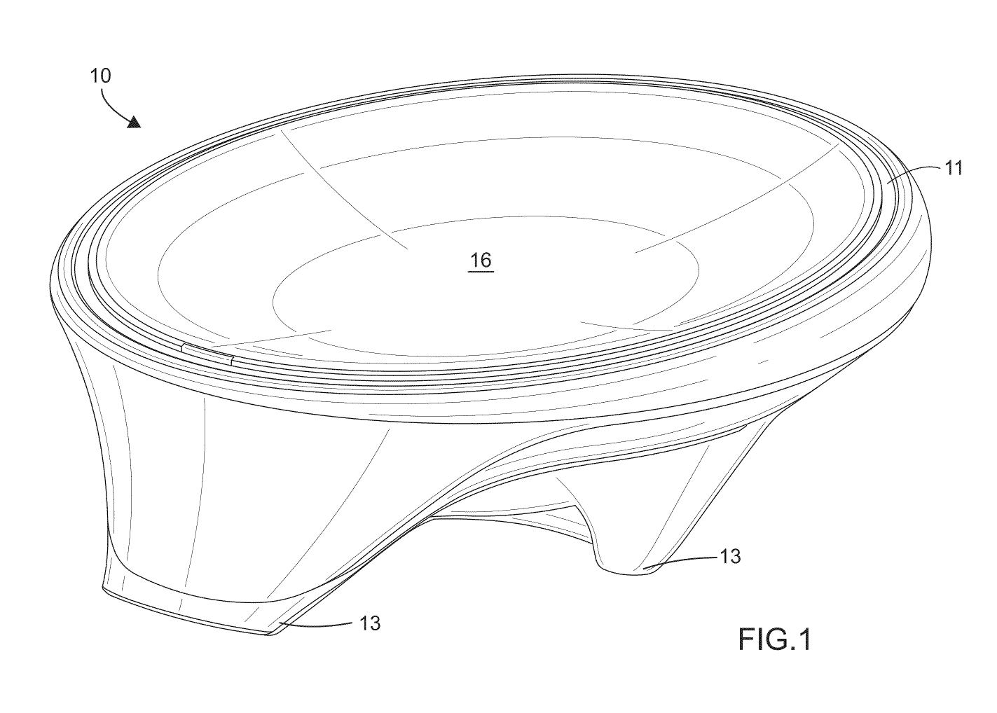

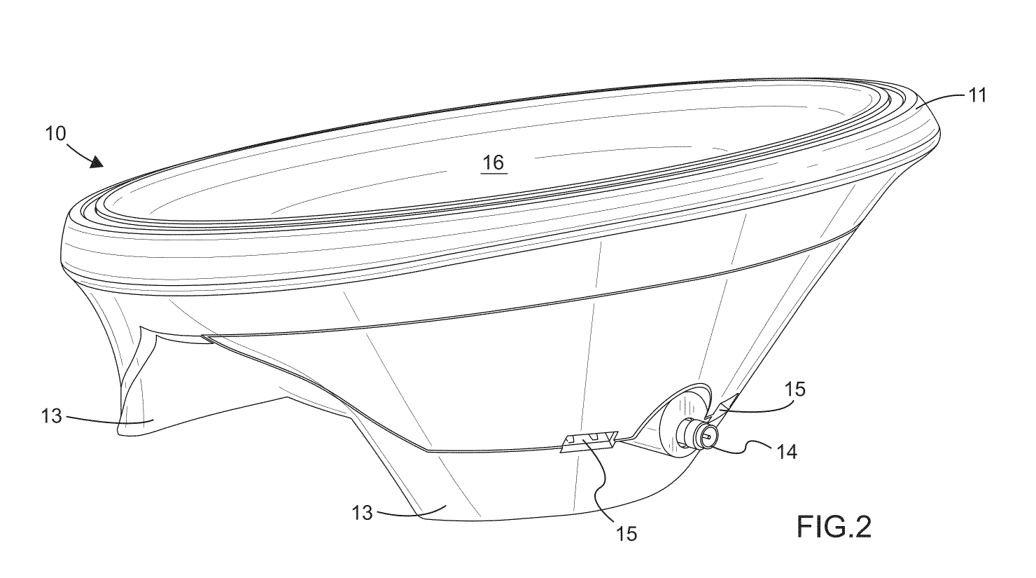

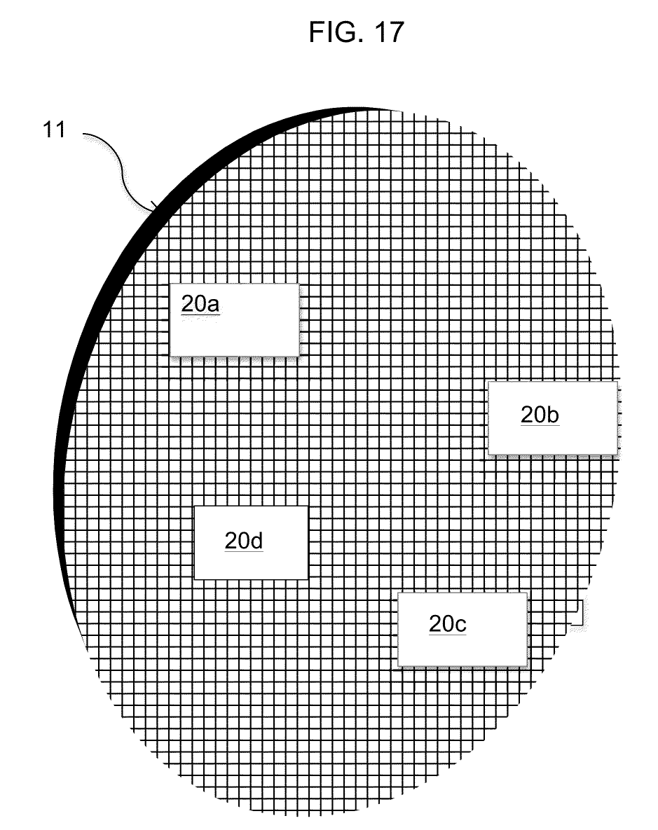

As illustrated in the FIGS. 1, 2 and 17, embodiments relate to an example of a wireless charging device 10 configured to charge an internally-arranged rechargeable battery of one or more electronic devices 20 (20a-20d) that are supported in a charging area 16 defined by a semi-hemispherical or bowl-shaped charging station 11. The semi-hemispherical or bowl-shaped charging station 11 may simultaneously charge one or more electronic devices 20 placed in the charging area 16, regardless of their respective location and spatial orientation relative to the wireless charging device 10. The devices 20 may vary in size and type, and may have the same or different functions, such as, for example, a convertible tablet, an electronic book (ebook) reader a smart phone, a smart watch, or a smart wearable device. The illustrated charging station 10 generally represents a universal wireless charging solution in that it accepts devices having different functions and/or manufacturers and does not require the devices 20 to be plugged into or otherwise connected to the charging station 11 in order for them to be charged. As will be discussed in greater detail, the charging station 11 may use electromagnetic energy to charge the battery of each respective electronic device 20.

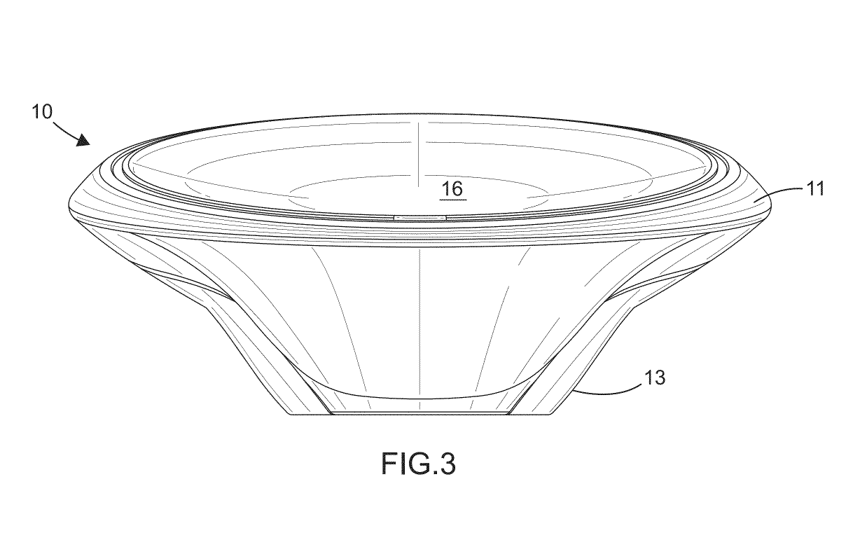

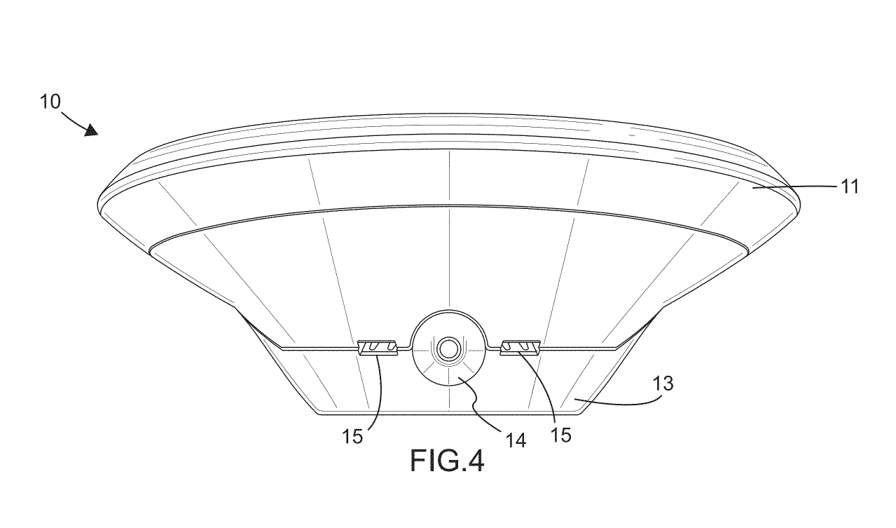

As illustrated in FIGS. 3 and 4, the charging station 11 may be supported by a plurality of support posts 13 which permits the wireless charging device 10 to be supported on a surface such as, for example, a desktop, table, floor, etc. The support posts 13 may extend from the outer peripheral surface of the charging platform 11. The support posts 13 may extend in a plane relative to the charging station 11 that permits receipt of one or more electronic devices into a charging area 16 and which permits a simultaneous charging sequence of the battery of each respective electronic devices 20 to be initiated. While embodiments illustrate a modular design structure of charging station 11 and support posts 13 of the charging device 10, embodiments are not limited thereto. For example, the charging station 11 and support posts may be separate structures that permit the charging station to be mechanically, and/or electro-mechanically, and/or electromagnetically, removeably attached to the support structure that may or may not include support posts. Alternatively, the charging station 11 may have a flat or otherwise planar bottommost surface which supports the charging station 11 on a support surface.

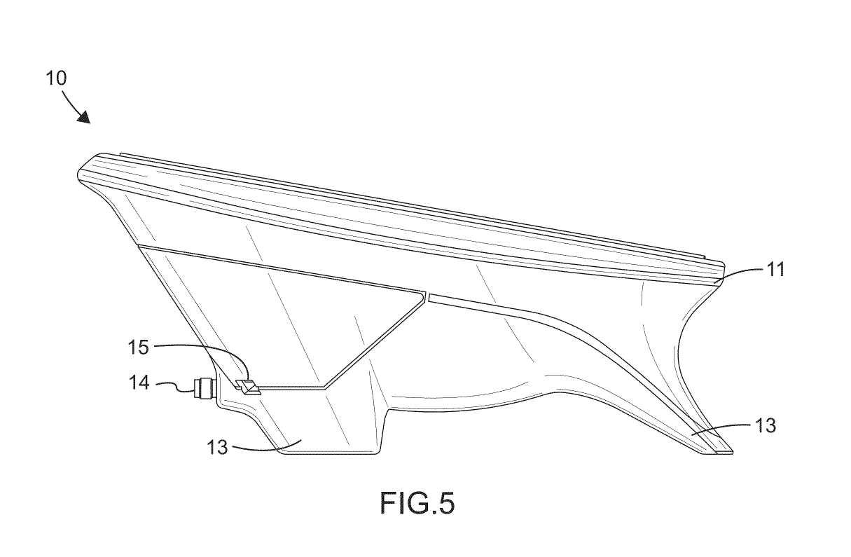

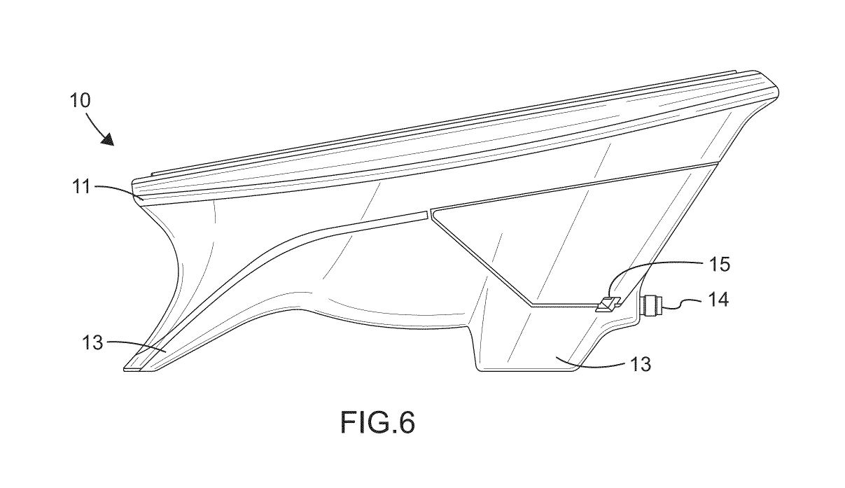

As illustrated in FIGS. 5 and 6, a power outlet 14 configured to operatively interface the wireless charging device 10 with an external power source may be provided at the one of the support posts 13. One or more Universal Serial Bus (USB) ports 15 to receive a user input device may also be provided on the same support post 13 that includes the power outlet 14. Alternatively or additionally, one or more Universal Serial Bus (USB) ports 15 may be provided on another of the support posts 13. The operational components of the wireless charging device 10 may be arranged in a housing composed of one or more lightweight, non-conductive materials such as, for example, a polymeric material and/or composite material and/or combinations thereof. Embodiments, however, are not limited to the use of such materials, and thus, may include other lightweight, non-conductive materials.

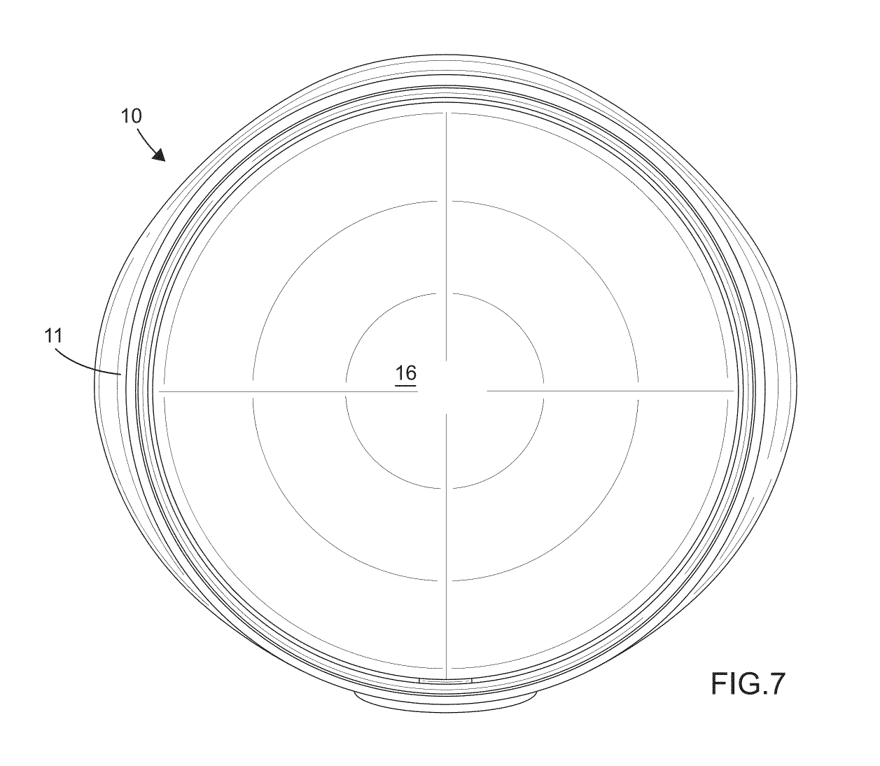

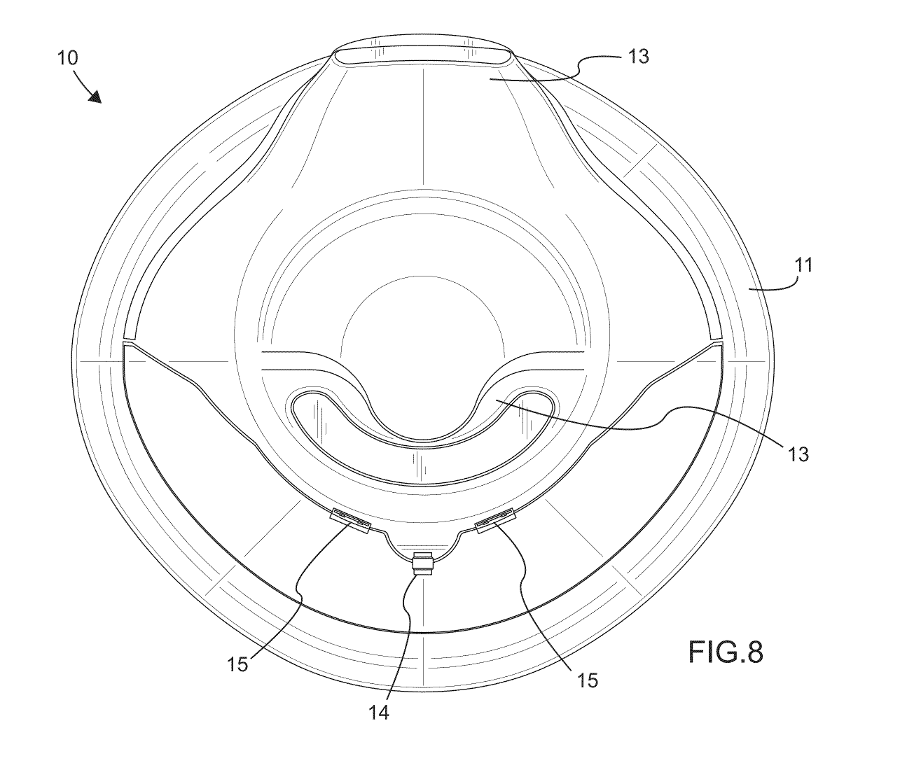

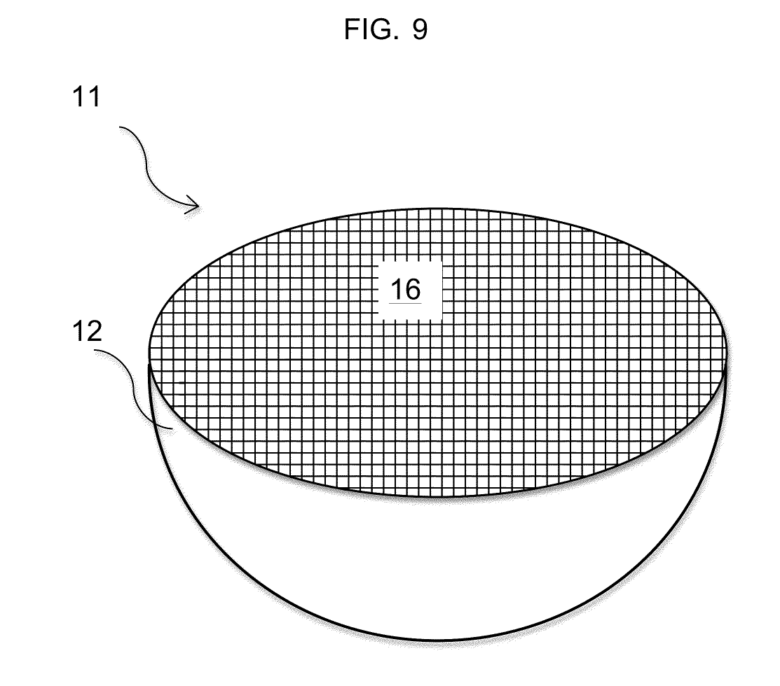

As illustrated in FIGS. 7 and 8, the charging station 11 has a charging or docking surface 12 upon which may be supported one or more electronic devices 20a, 20b, 20c, 20d to permit simultaneous charging of the internal battery of each electronic device 20a, 20b, 20c, 20d during a power charging sequence regardless of location and spatial orientation relative to the charging surface 12. As illustrated in FIG. 9, the charging station 11 may have a semi-hemispherical or concave geometric shape, cross-section or geometric configuration defining a charging area 16 that corresponds to the hemispherical volume of the charging station 11. The geometric shape of the charging station 11 also permits the respective battery of one or more electronic devices 20a, 20b, 20c, 20d, when received at or in the charging area 16, to be simultaneously charged regardless of location and spatial orientation relative to the charging surface 12.

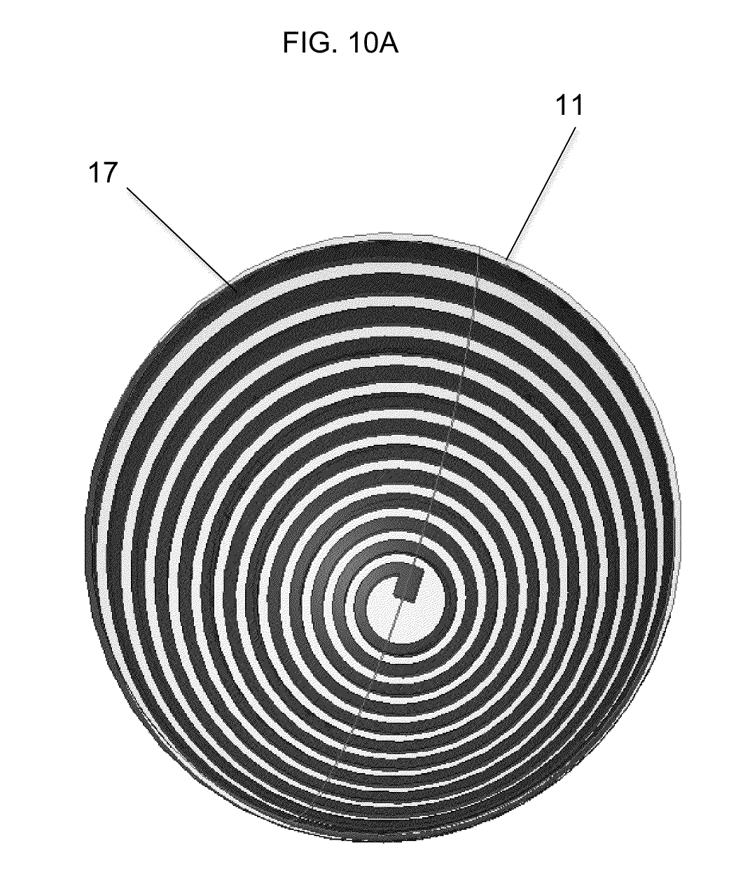

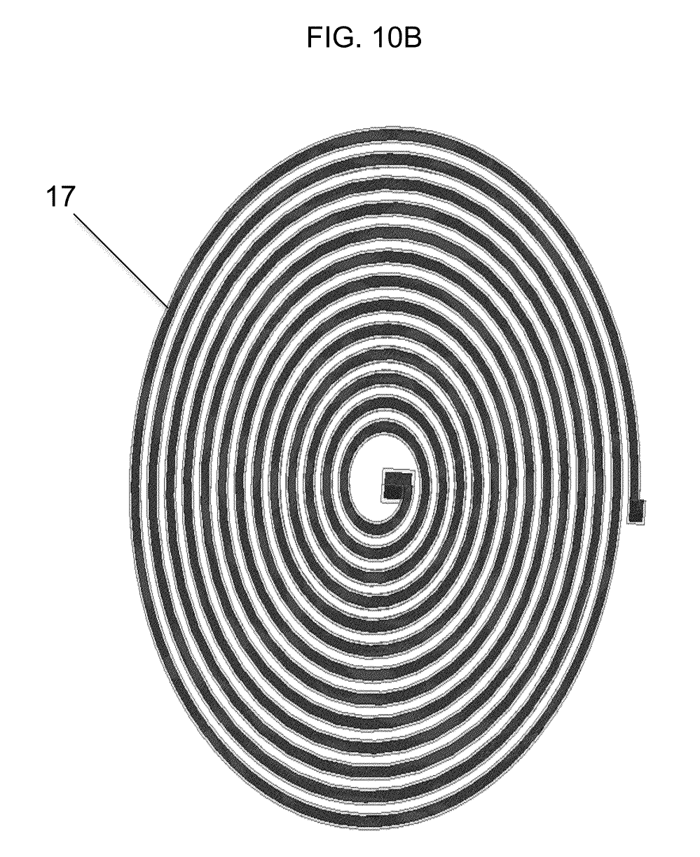

As illustrated in FIGS. 10A and 10B, provided at the outer hemispherical surface of the charging station 11 is a power transmitter, such as a transmitter coil 17 that is wound in spiral pattern configuration, that when induced by an electric pulse or signal, creates an electromagnetic field 30 confined generally to the charging area 16 having a volumetric shape, cross-section, or geometric configuration that corresponds to the shape, cross-section, or configuration of the charging station 11, i.e., semi-hemispherical or , concave. The electromagnetic field 30 may then be rectified by the receiver circuit of the electronic device 20 into DC power during a power charging sequence.

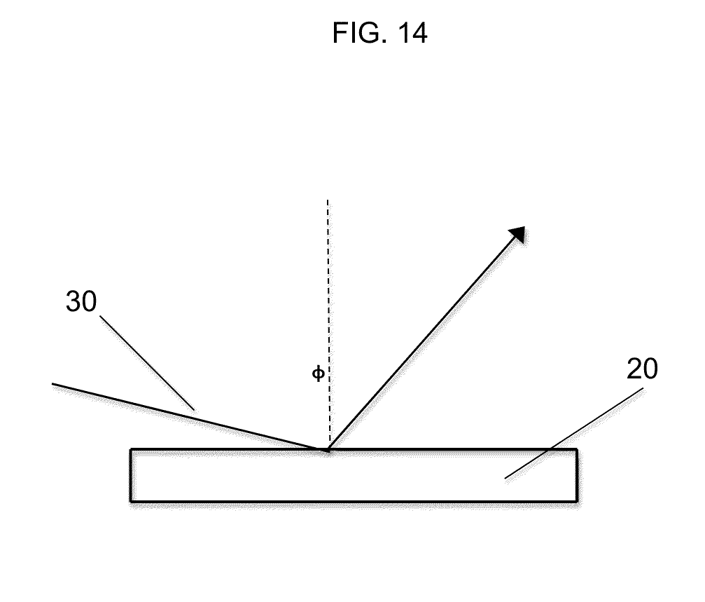

As illustrated in FIG. 14, the electromagnetic field 30 generated by the transmitter coil may have a predetermined angle of incidence Φ relative to a plane of the receiver coil of the electronic device 20. The predetermined angle of incidence Φ may be substantially ninety-degrees. The transmitter coil 17 includes a conductive wire that is attached to the outer hemispherical surface of the charging station 11 via a suitable adhesive.

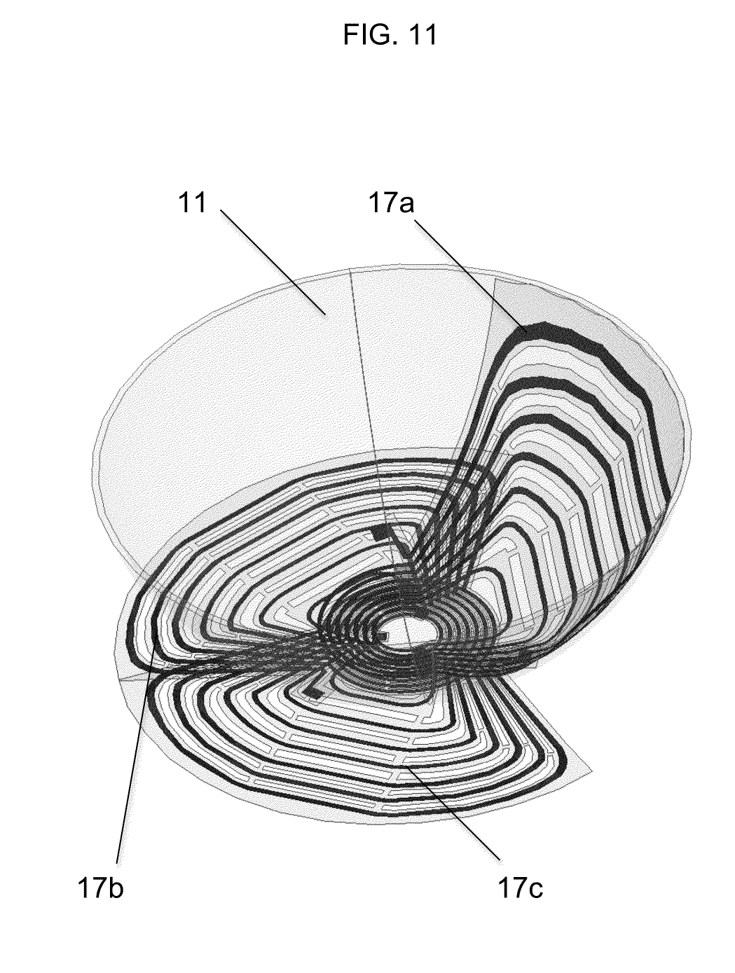

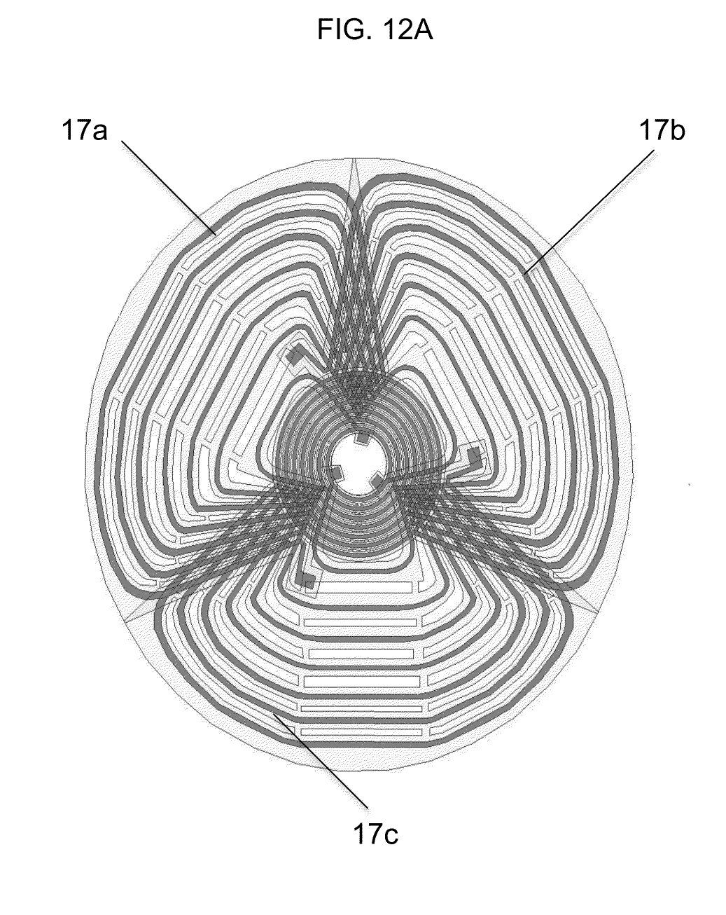

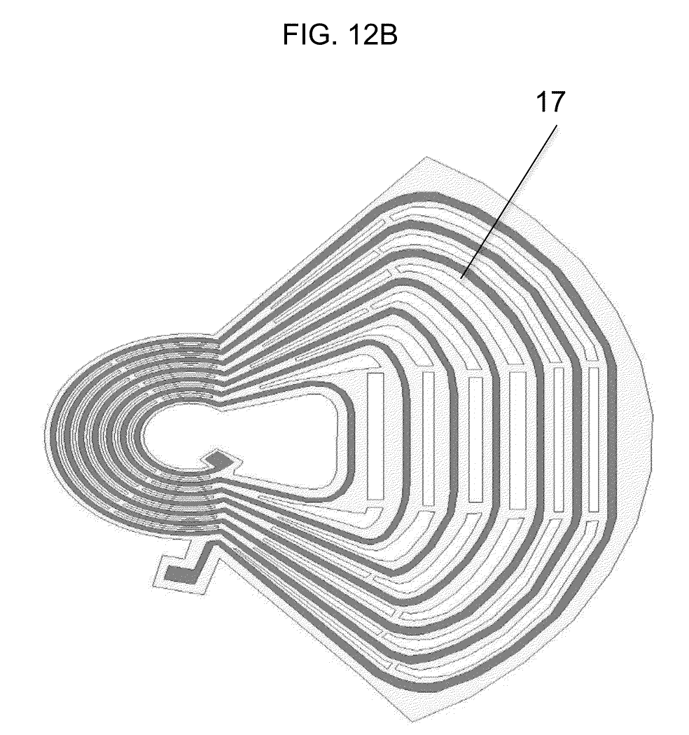

As illustrated in FIGS. 11, 12A and 12B, provided at the outer hemispherical surface of the charging station 11 is a power transmitter that includes a plurality of transmitter coils 17a, 17b, 17c that each includes a conductive wire attached to the outer hemispherical surface of the charging station 11 via a suitable adhesive. The transmitter coils 17a, 17b, 17c may be arranged on the outer hemispherical surface of the charging station 11 so as to at least partially overlap with each other at certain regions of the charging station 11. Embodiments, however, are not restricted to such an arrangement, and may include an arrangement whereby the transmitter coils 17a, 17b, 17c are arranged spaced apart on the outer hemispherical surface of the charging station 11.

The transmitter coils 17a, 17b, 17c operate such that, when induced by an electric pulse or signal, create a plurality of electromagnetic fields 30 in the charging area 16 which the receiver circuit of the electronic device 20 may rectify into DC power during a charging sequence. In accordance with embodiments, a power charging sequence may initiated at the charging area 16 through the selective transmission of a pulsed signal to at least one of the transmitter coils 17a, 17b, 17c. In this way, the charging device 10 may selectively generate an electromagnetic field 30 at selective regions of the charging station 11 by exciting one or any combination of the transmitter coils 17a, 17b, 17c.

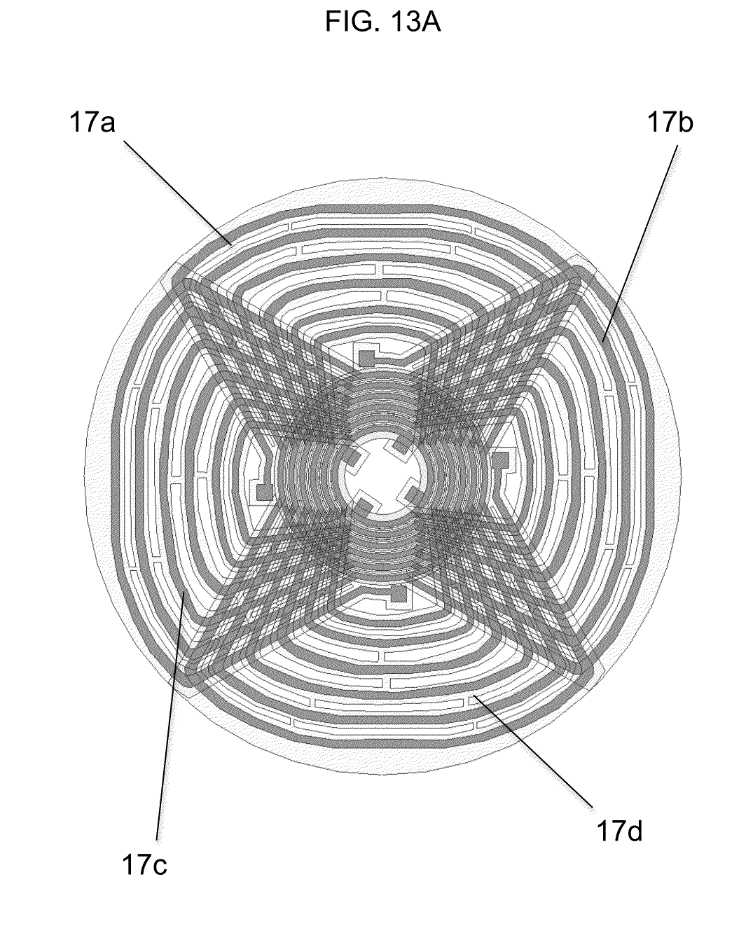

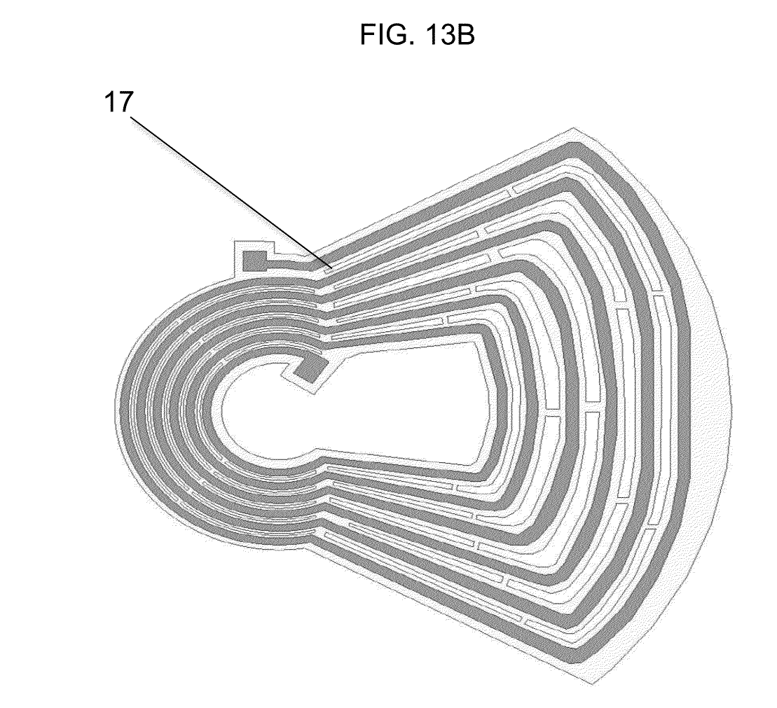

As illustrated in FIGS. 13A and 13B, provided at the outer hemispherical surface of the charging station 11 is a power transmitter that includes a plurality of transmitter coils 17a, 17b, 17c, 17d that each includes a conductive wire attached to the outer hemispherical surface of the charging station 11 via a suitable adhesive. The transmitter coils 17a, 17b, 17c, 17d may be arranged on the outer hemispherical surface of the charging station 11 so as to at least partially overlap with each other at certain regions of the charging station 11. Embodiments, however, are not restricted to such an arrangement, and may include an arrangement whereby the transmitter coils 17a, 17b, 17c, 17d are arranged spaced apart on the outer hemispherical surface of the charging station 11.

The transmitter coils 17a, 17b, 17c, 17d operate such that, when induced by an electric pulse or signal, create a plurality of electromagnetic fields 30 in the charging area 16 which the receiver circuit of the electronic device 20 may rectify into DC power during a charging sequence. In accordance with embodiments, a power charging sequence may initiated at the charging area 16 through the selective transmission of a pulsed signal to at least one of the transmitter coils 17a, 17b, 17c, 17d. In this way, the charging device 10 may selectively generate an electromagnetic field 30 at selective regions of the charging station 11 by exciting one or any combination of the transmitter coils 17a, 17b, 17c, 17d.

By virtue of the semi-hemispherical or concave geometric shape, cross-section or geometric configuration of the charging station 11, one or more electronic devices 20 may be charged simultaneously when at the charging area 16 that corresponds to the hemispherical volume of the charging station 11, regardless of the location and spatial orientation of the receiving coil of the electronic devices 20 relative to the charging surface 12.

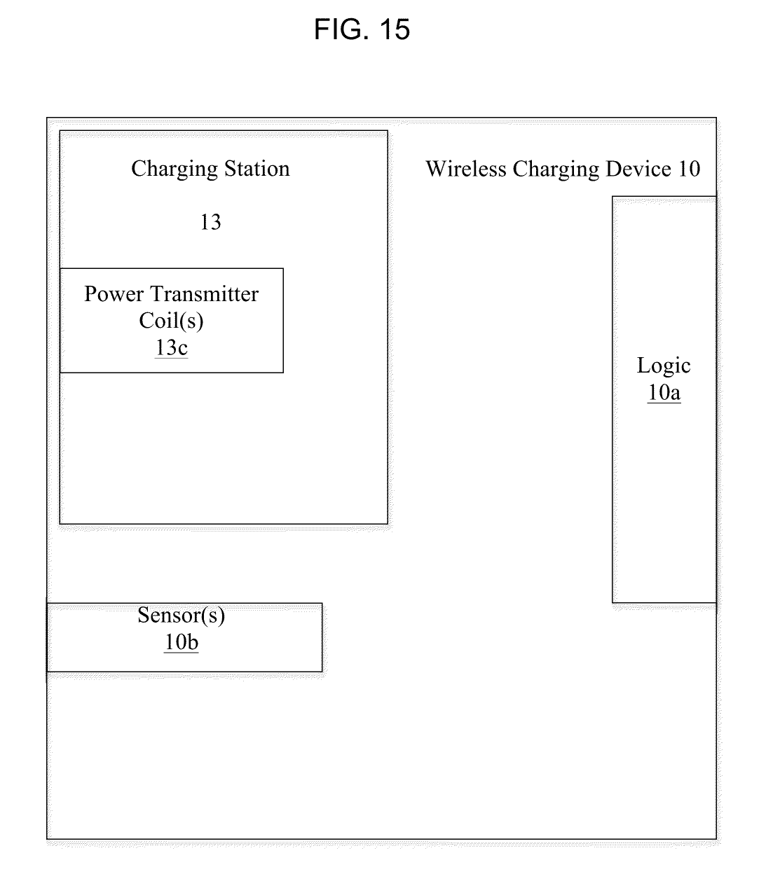

As illustrated in FIG. 15, internally arranged in the charging device 10 is various electric circuitry and other components. For instance, the wireless charging device 10 may include logic 10a and one or more sensors 10b operatively connected thereto for proximity detection and/or motion detection. For instance, when an electronic device 20 is detected in the charging area 16 of the charging station 11, the sensor(s) 10b may send a signal to the logic 10a to selectively and automatically initiate a charging sequence. Alternatively and/or additionally, when an electronic device 20 is detected by the sensor(s) 10b to have broken a certain spatial threshold, such as, for example, the plane defined by the top rim of the charging station 11, the sensor(s) 10b may send a signal to the logic 10a to selectively initiate and automatically initiate a charging sequence. The charging device 10, in such instances, may be automatically activated from an “off” or deactivated operating status.

Alternatively and/or additionally, the sensor(s) 10b may be configured to detect when a “foreign” object and/or device that is not capable of being charged has broken the spatial threshold noted herein and/or has been placed in the charging station 11. For example, when the sensor(s) 10b has detected that an electronic device 20 capable of being charged has broken the spatial threshold and/or has been placed in the charging station 11, a charging sequence is automatically initiated whereby the electronic device 20 will provide a “chirping” current using an on/off consumption pattern (or another pattern). The sensor(s) 10b may thus detect consumption with a current draw, and if this consumption pattern is not detected, a visual or audible alarm will be activated to turn off or otherwise cease the charging sequence (of other electronic devices presently undergoing a charging sequence). In this way, the charging device 10 does not heat up metal objects or other objects during a charging sequence. The logic 10a may be configured to periodically (at a predetermined time frequency) activate/deactivate the charging device 10 to challenge devices placed in the charging station 11 to perform this process.

The logic 10a may also be configured to detect the location of the receiver coil of each electronic device 20 relative to the charging surface 12 of the charging station 11. In this way, the logic 10a may selectively send an electric pulse or signal to the transmitter coil(s) 17 to induce an electromagnetic field at a specific region of the charging station 11. In that way, a detection of the receiver coil automatically initiates the power charging sequence. A user may also receive audio or visual confirmation of a charging status.

As illustrated in FIGC. 16A to 16C, methods 40 of wirelessly charging an electronic device is provided. The method 40 in accordance with embodiments may be implemented as a set of logic and/or firmware instructions stored in a machine- or computer-readable storage medium such as random access memory (RAM), read only memory (ROM), programmable ROM (PROM), flash memory, etc., in configurable logic such as, for example, programmable logic arrays (PLAs), field programmable gate arrays (FPGAs), complex programmable logic devices (CPLDs), in fixed functionality logic hardware using circuit technology such as, for example, application specific integrated circuit (ASIC), complementary metal oxide semiconductor (CMOS) or transistor-transistor logic (TTL) technology, or any combination thereof For example, computer program code to carry out operations shown in the method 40 may be written in any combination of one or more programming languages, including an object oriented programming language such as Java, Smalltalk, C++ or the like and conventional procedural programming languages, such as the “C” programming language or similar programming languages. In accordance with embodiments, the method 40 may be implemented in the logic 10a of the wireless charging device 10, as already discussed herein.

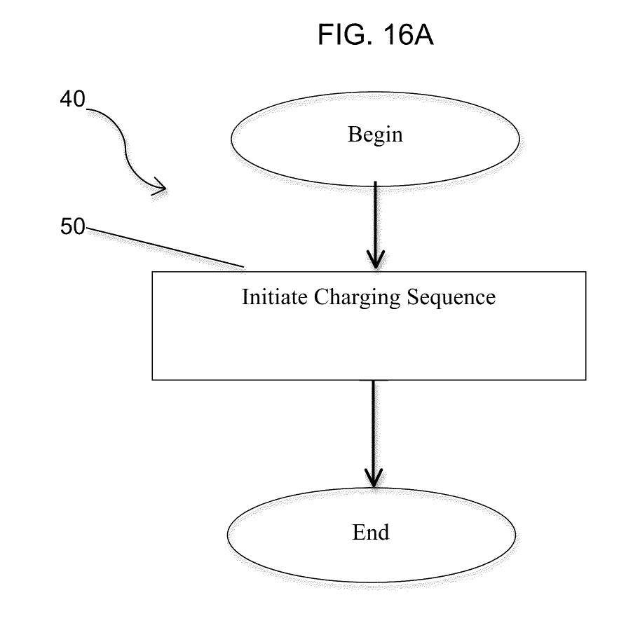

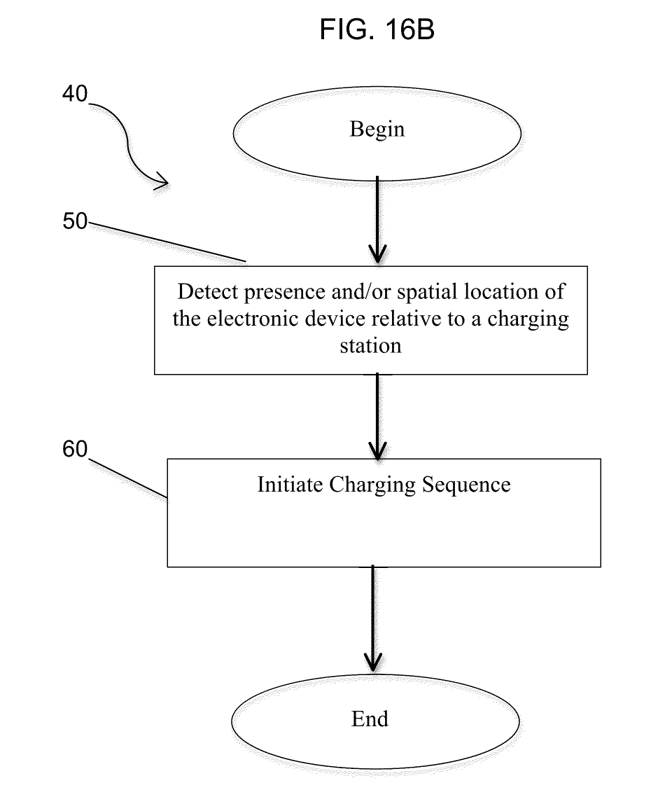

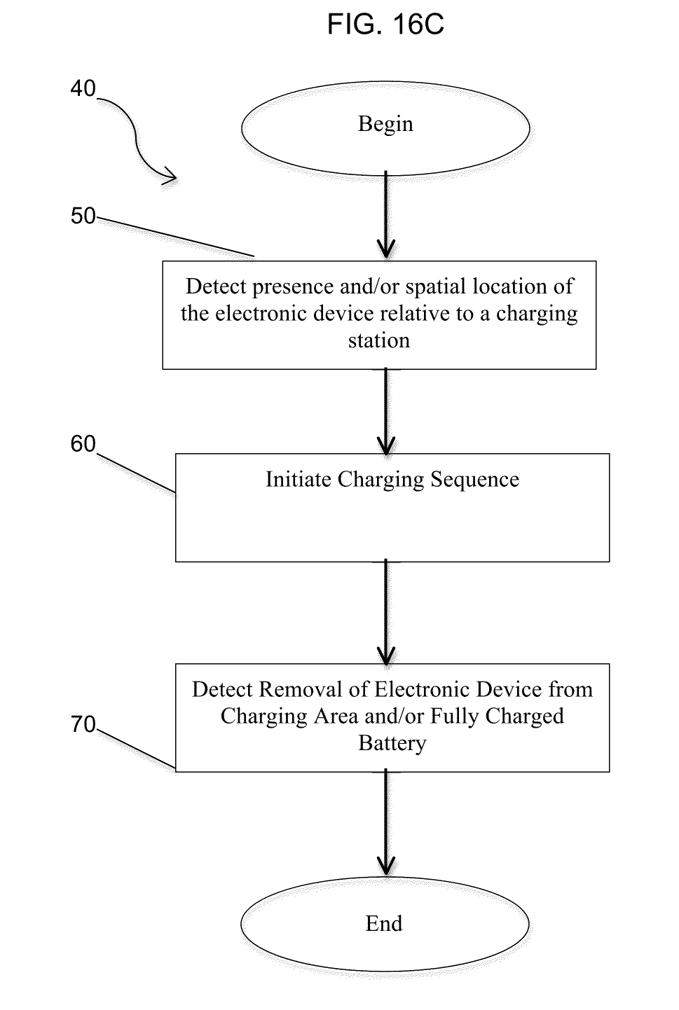

As illustrated in FIG. 16A, processing block 50 initiates a power charging sequence at a concave-shaped charging surface defining a charging area by inducing at least one electromagnetic field into the charging area.

As illustrated in FIG. 16B, processing block 50 detects the presence and/or spatial position of an electronic device relative to a charging station. As already noted herein, the charging station has a charging surface with one or more power transmitter coils. In one example, block 50 may use a low power signal and acknowledgement handshake to detect the presence and/or location of the adjacent power receiver of the electronic device at the charging area.

At block 60, an affirmation of the detection of the electronic device in the charging area may result in an automatic initiation of a power charging sequence at the charging surface of the charging station. This may be conducted by transmitting a charge signal to at least one region of the charging surface. A visual and/or audio indication of the affirmation indicating the operational coupling between a power transmitter(s) and the power receiver of the electronic device may be provided.

As illustrated in FIG. 16C, processing block 50 detects the presence of an electronic device relative to a charging station. Again, as already noted herein, the charging station has a charging surface with one or more power transmitter coils. In one example, block 50 may use a low power signal and acknowledgement handshake to detect the presence and/or location of the adjacent power receiver of the electronic device at the charging area.

At block 60, an affirmation of the detection of the electronic device in the charging area may result in an automatic initiation of a power charging sequence at the charging surface of the charging station. This may be conducted by transmitting a charge signal to at least one region of the charging surface. A visual and/or audio indication of the affirmation indicating the operational coupling between a power transmitter(s) and the power receiver of the electronic device may be provided.

Processing block 70 detects whether the electronic device has been removed from the charging area and/or the charging sequence is complete (i.e., the battery has been recharged to its greatest capacity), whereby the power charging sequence is ended.

### Additional Notes and Examples

Example One may include a wireless charging device, comprising a concave-shaped charging platform defining a charging area, at least one transmitter coil arranged about the charging platform, and logic to initiate a power charging sequence at the charging area via transmission of a pulsed signal to the at least one transmitter coil to induce an electromagnetic field from the at least one transmitter coil and into the charging area.

Example Two may include the wireless charging device of Example One, wherein the at least one transmitter coil extends in a spiral about the charging platform.

Example Three may include the wireless charging device of Example One, wherein the at least one transmitter comprises an array of transmitter coils arranged around the charging platform.

Example Four may include the wireless charging device of Example Three, wherein the array of transmitter coils comprises a first transmitter coil provided at a first region of the charging platform, a second transmitter coil provided at a second region of the charging platform, and a third transmitter coil provided at a third region of the charging platform.

Example Five may include the wireless charging device of Example Four, wherein the logic is to selectively transmit a pulsed signal to at least one of the first transmitter coil, the second transmitter coil and the third transmitter coil to initiate the power charging sequence.

Example Six may include the wireless charging device of Example One, wherein the electromagnetic field is to have a predetermined angle of incidence relative to a plane of the at least one receiver coil.

Example Seven may include the wireless charging device of Example Six, wherein the predetermined angle of incidence is substantially ninety-degrees.

Example Eight may include the wireless charging device of any one of Examples One to Seven, and further comprises a sensor configured to detect the presence of the at least one electronic device, wherein the logic is to initiate the power charging sequence at the charging area based upon the detection.

Example Nine may include at least one computer readable storage medium comprising a set of instructions which, if executed by a wireless charging device, cause the wireless charging device initiate a power charging sequence at a concave-shaped charging surface defining a charging area via inducement of at least one electromagnetic field into the charging area.

Example Ten may include the at least one computer readable storage medium of Example Nine, wherein the instructions, if executed, cause the wireless charging device to selectively transmit a pulse signal to at least one transmitter coil to initiate the power charging sequence.

Example Eleven may include the at least one computer readable storage medium of Example Nine, wherein the at least one electromagnetic field is to be induced in an array of transmitter coils arranged around the charging platform.

Example Twelve may include the at least one computer readable storage medium of Example Eleven, wherein the at least one electromagnetic field is to be induced in one or more of a first transmitter coil provided at a first region of the charging platform, a second transmitter coil provided at a second region of the charging platform, and a third transmitter coil provided at a third region of the charging platform.

Example Thirteen may include the at least one computer readable storage medium of Example Twelve, wherein the instructions, if executed, cause the wireless charging device to selectively send a pulsed signal to at least one of the first transmitter coil, the second transmitter coil and the third transmitter coil to initiate the power charging sequence.

Example Fourteen may include the at least one computer readable storage medium of Example Nine, wherein the instructions, if executed, cause the wireless charging device to induce at least one electromagnetic field having a predetermined angle of incidence relative to a plane of at least one receiver coil to initiate the power charging sequence.

Example Fifteen may include the at least one computer readable storage medium of Example Fourteen, wherein the predetermined angle of incidence is substantially ninety-degrees.

Example Sixteen may include a method of wirelessly charging an electronic device, comprising initiating a power charging sequence at a concave-shaped charging surface defining a charging area via inducement of at least one electromagnetic field into the charging area.

Example Seventeen may include the method of Example Sixteen, wherein initiating the power charging sequence comprises selectively transmitting a charge signal to at least one region of the charging surface.

Example Eighteen may include the method of Example Sixteen, wherein initiating the power charging sequence comprises selectively transmitting a pulse signal to at least one transmitter coil.

Example Nineteen may include the method of Example Eighteen, wherein the at least one electromagnetic field is induced in an array of transmitter coils arranged around the charging platform.

Example Twenty may include the method of Example Sixteen, wherein the at least one electromagnetic field is induced in one or more of a first transmitter coil provided at a first region of the charging platform, a second transmitter coil provided at a second region of the charging platform, and a third transmitter coil provided at a third region of the charging platform.

Example Twenty-One may include the method of Example Sixteen, wherein initiating the power charging sequence comprises inducing at least one electromagnetic field having a predetermined angle of incidence relative to a plane of at least one receiver coil.

Example Twenty-Two may include the method of Example Twenty-One, wherein the predetermined angle of incidence is substantially ninety-degrees.

Example Twenty-Three may include the method of any one of Examples Sixteen to Twenty-Two, and further comprises detecting a removal of the electronic device from the charging area.

Example Twenty-Four may include the method of Example Twenty-Four, and further comprises automatically ending the power charging sequence when removal of the electronic device from the charging area has been detected.

Example Twenty-Five may include a wireless charging device, comprising means for charging at least one electronic device, said means having a concave-shaped charging station defining a charging area and at least one transmitter coil arranged about the charging platform, and means for initiating a power charging sequence at the charging area via transmission of a pulsed signal to the at least one transmitter coil to induce an electromagnetic field from the at least one transmitter coil into the charging area.

Example Twenty-Six may include a wireless charging device, comprising, means for charging at least one electronic device, said means having a concave-shaped charging station defining a charging area and a plurality of transmitter coils arranged about the charging platform, said means configured to initiate a power charging sequence at the charging area via transmission of a pulsed signal to the at least one of the transmitter coils to induce an electromagnetic field into the charging area.

Example Twenty-Seven may include a wireless charging device, comprising: a concave-shaped charging platform defining a charging area; at least one transmitter coil arranged about the charging platform; and logic to detect a location of at least one electronic device in the charging area, and initiate a power charging sequence at the charging area by transmitting a pulsed signal to the at least one transmitter coil to induce an electromagnetic field from the at least one transmitter coil and into the charging area.

Example Twenty-Eight may include at least one computer readable storage medium comprising a set of instructions which, if executed by a wireless charging device, cause the wireless charging device to detect a location of at least one electronic device at a concave-shaped charging surface defining a charging area, and initiate a power charging sequence at the charging area by inducing at least one electromagnetic field into the charging area.

Example Twenty-Nine may include a method of wirelessly charging an electronic device, comprising detecting a location of at least one electronic device at a charging area of a charging platform defined by a concave-shaped charging surface, and initiating a power charging sequence at the charging area by inducing at least one electromagnetic field into the charging area.

Example Thirty may include a wireless charging device, comprising means for charging at least one electronic device, said means having a concave-shaped charging station defining a charging area and a plurality of transmitter coils arranged about the charging platform, said means configured to detect a location of the at least one electronic device in the charging area and initiate a power charging sequence at the charging area by transmitting a pulsed signal to the at least one of the transmitter coils to induce an electromagnetic field into the charging area.

Example Thirty-One may include a wireless charging device, comprising means for charging at least one electronic device, said means having a concave-shaped charging station defining a charging area and at least one transmitter coil arranged about the charging platform, means for detecting a location of the at least one electronic device in the charging area, and means for initiating a power charging sequence at the charging area by transmitting a pulsed signal to the at least one transmitter coil to induce an electromagnetic field from the at least one transmitter coil into the charging area.

Embodiments are applicable for use with all types of battery powered devices, such as, for example, a smart phone, mobile Internet device (MID), smart tablet, convertible tablet, notebook computer, or other similar portable device.

The term “coupled” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A wireless charging device, comprising:
a concave-shaped charging platform defining a charging area;
at least one transmitter coil arranged about the charging platform; and
logic to:
initiate a power charging sequence at the charging area via transmission of a pulsed signal to the at least one transmitter coil to induce an electromagnetic field from the at least one transmitter coil into the charging area.

2. The wireless charging device of claim 1, wherein the at least one transmitter coil extends in a spiral about the charging platform.

3. The wireless charging device of claim 1, wherein the at least one transmitter comprises an array of transmitter coils arranged around the charging platform.

4. The wireless charging device of claim 3, wherein the array of transmitter coils comprises:
a first transmitter coil provided at a first region of the charging platform;
a second transmitter coil provided at a second region of the charging platform; and
a third transmitter coil provided at a third region of the charging platform.

5. The wireless charging device of claim 4, wherein the logic is to selectively transmit a pulsed signal to at least one of the first transmitter coil, the second transmitter coil and the third transmitter coil to initiate the power charging sequence.

6. The wireless charging device of claim 1, wherein the electromagnetic field is to have a predetermined angle of incidence relative to a plane of the at least one receiver coil.

7. The wireless charging device of claim 6, wherein the predetermined angle of incidence is substantially ninety-degrees.

8. The wireless charging device of claim 1, further comprising at least one sensor configured to detect a presence of at least one electronic device, wherein the logic is to initiate the power charging sequence at the charging area based upon the detection.

9. At least one computer readable storage medium comprising a set of instructions which, if executed by a wireless charging device, cause the wireless charging device to:
initiate a power charging sequence at a concave-shaped charging surface defining a charging area via inducement of at least one electromagnetic field into the charging area.

10. The at least one computer readable storage medium of claim 9, wherein the instructions, if executed, cause the wireless charging device to selectively transmit a pulse signal to at least one transmitter coil to initiate the power charging sequence.

11. The at least one computer readable storage medium of claim 9, wherein the at least one electromagnetic field is to be induced in an array of transmitter coils arranged around the charging platform.

12. The at least one computer readable storage medium of claim 11, wherein the at least one electromagnetic field is to be induced in one or more of a first transmitter coil provided at a first region of the charging platform, a second transmitter coil provided at a second region of the charging platform, and a third transmitter coil provided at a third region of the charging platform.

13. The at least one computer readable storage medium of claim 12, wherein the instructions, if executed, cause the wireless charging device to selectively transmit a pulsed signal to at least one of the first transmitter coil, the second transmitter coil and the third transmitter coil to initiate the power charging sequence.

14. The at least one computer readable storage medium of claim 9, wherein the instructions, if executed, cause the wireless charging device to induce at least one electromagnetic field having a predetermined angle of incidence relative to a plane of at least one receiver coil to initiate the power charging sequence.

15. The at least one computer readable storage medium of claim 14, wherein the predetermined angle of incidence is substantially ninety-degrees.

16. A method of wirelessly charging an electronic device, comprising:
initiating a power charging sequence at a concave-shaped charging surface defining a charging area via inducement of at least one electromagnetic field into the charging area.

17. The method of claim 16, wherein initiating the power charging sequence comprises selectively transmitting a charge signal to at least one region of the charging surface.

18. The method of claim 16, wherein initiating the power charging sequence comprises selectively transmitting a pulse signal to at least one transmitter coil provided adjacent the concave-shaped charging surface.

19. The method of claim 18, wherein the at least one electromagnetic field is induced in an array of transmitter coils arranged around the charging platform.

20. The method of claim 16, wherein the at least one electromagnetic field is induced in one or more of a first transmitter coil provided at a first region of the charging platform, a second transmitter coil provided at a second region of the charging platform, and a third transmitter coil provided at a third region of the charging platform.

21. The method of claim 16, wherein initiating the power charging sequence comprises inducing at least one electromagnetic field having a predetermined angle of incidence relative to a plane of at least one receiver coil.

22. The method of claim 21, wherein the predetermined angle of incidence is substantially ninety-degrees.

23. The method of claim 16, further comprising detecting a removal of the electronic device from the charging area.

24. The method of claim 23, further comprising automatically ending the power charging sequence when removal of the electronic device from the charging area has been detected.
